(19) United States
(12) Patent Application Publication
(10) Pub. No.: US 2006/0197975 A1
(43) Pub. Date: Sep. 7, 2006

(54) Method for printing from a handheld computer

(76) Inventors: David E. Chevalier, Crystal Lake, IL (US); James C. Baker, Crystal Lake, IL (US); Steven H. Goode, Barrington, IL (US); Henry L. Kazecki, Arlington Heights, IL (US)

Correspondence Address: CHERSKOV & FLAYNIK;Civic Opera Building, Suite 1447, 20 N. Wacker Drive, Chicago, IL, 60606, US

(21) Appl. No.: 11/136,197

(22) Filed: May 24, 2005

Related U.S. Application Data
(60) Provisional application No. 60/658,042, filed on Mar. 1, 2005.

(51) Int. Cl. G06F 3/12

(52) U.S. Cl. 358/1.15

(57) ABSTRACT

A method for printing programs and/or data from a handheld or remote computer 101 to each one of a plurality of printers 109, includes providing a secondary computer 105 having a plurality of printer drivers that facilitate the printing of the remote computer programs and/or data by one or more of the printers 109, sending the remote computer program from the remote computer 101 to the secondary computer 105 via an interface 103, and providing an interface 107 between the secondary computer 105 and the plurality of printers 109.

This application is based on U.S. Provisional Application No. 60/658,042, filed on Mar. 1, 2005.

### BACKGROUND OF THE INVENTION

1. Field of the Invention

The present invention relates to printing from a remote computer and more particularly to printing from a remote computer using a secondary computer.

2. Background of the Prior Art

Remote computing devices are being used by business people for personal information management and in classrooms as low cost educational tools. As computing power continues to increase and computing cost continues to decrease, these remote computing devices have become capable of executing many sophisticated programs such as word processors, spread sheets, etc. Likewise, as memory costs continue to decrease and embedded cameras become commonplace, photograph capability and image storage programs are also implemented in these remote computing devices. Common remote computers use operating systems from Palm OS or Windows Mobile from Microsoft. Many Palm OS devices are made by PalmOne and are called Palm handhelds (“handheld”). Windows Mobile devices are made by many manufacturers such as Dell, HP, and Toshiba and are typically called Pocket PC handhelds (“handheld”). Handheld remote computers are also capable of providing cellular phone functionality with voice and internet access. In the industry these are commonly known as smart phones.

With the numerous programs and increased processing power now available on these handheld computers, the ability to print from handheld computers has become a useful and desirable function. For a computing device to send an application program to a printer, the device must be capable of converting the application program into a form the printer can read and process. Also, the computing device must communicate with the printer and send the proper commands to control the printer. The software required to perform these tasks is typically called a printer driver. Each of the hundreds or thousands of existing printers requires its own printer driver to be installed on the computing device to enable printing to each specific printer.

Current printing applications or printing programs for handheld computers developed by software companies include InStep Print for Palm OS by the InStep Group, Inc., TealPrint by TealPoint Software, PalmPrint by Stevens Creek Software LLC, BtPrintPro by IS/Complete, Inc. and PrintBoy Premium for Palm OS handhelds by Bachmann Software. These printing programs all include printer drivers to support printing; however, the number of printer drivers required creates problems for these printing programs. Supporting a wide range of printers requires a larger number of printer drivers to be included with the printing software on the handheld. This consumes enormous amounts of memory, which is a precious commodity in handhelds. Other printer programs only support a small subset of printers limiting their usefulness. If a supported printer is not available, the user cannot print from the handheld.

Printer manufacturers provide working drivers for their printer to work with commonly used desktop and laptop computers such as Windows OS and Macintosh computers. These drivers are tested and functional. However, it is the software company that generally must provide the printer drivers on the handheld; thus, it is virtually impossible for a company to test all possible printers. Software companies have the ability to develop only a relatively small number of printer drivers to cooperate with different printers, each printer requiring a distinct graphics “language” to communicate with a handheld.

Generally, printing programs, including printer drivers, tend to be difficult to configure. Users must select the appropriate printer driver for the printer they intend to use. If the user desires to print from a different printer, he or she must determine which printer driver is needed and successfully reconfigure the printing software. A need exists for a handheld printing method that works with virtually all existing printers, does not require printer drivers on the handheld, and does not require complex and changing configuration requirements.

### SUMMARY OF THE INVENTION

It is an object of the present invention to overcome many of the disadvantages associated with printing from a remote or handheld computer.

A principle object of the present invention is to provide a method for printing from a remote or handheld computer that does not include a printer driver. A feature of the printing method is to provide a secondary computer that includes a printer driver that promotes the printing of a handheld computer program by a printer. An advantage of the printing method is that memory in the handheld computer is not used to store the printer driver thereby increasing the memory for application programs.

Another object of the present invention is to provide a method for printing from a handheld computer to a plurality of printers with distinct printer drivers. A feature of the printing method is to provide a secondary computer that includes multiple distinct printer drivers that promote the printing of a handheld computer program by each one of the plurality of printers. An advantage of the printing method is that the secondary computer has sufficient memory capacity for all printer drivers required to promote the printing of a program from the handheld computer by each one of the plurality of printers.

Still another object of the present invention is to provide a method for printing from each one of a plurality of handheld computers to each of a plurality of printers with distinct printer drivers. A feature of the printing method is to provide a secondary computer that interfaces with each of the handheld computers. Another feature of the printing method is to provide a secondary computer that includes multiple distinct printer drivers that promote the printing of a program from each one of the plurality of handheld computers, the total programs from all the handheld computers being printed by each one of said plurality of printers. An advantage of the printing method is that all files from multiple handheld computers are printable by each of a plurality of printers thereby promoting file review of all handheld computers by individuals at different locations.

Yet another object of the present invention is to provide a method for printing Internet content via a remote computer. A feature of the printing method is to provide a secondary computer having a printer driver that facilitates the printing of the Internet content. Another feature of the printing method is to send a uniform resource locator from the remote computer to the secondary computer. An advantage of the printing method is that Internet content is printed by the direction of the remote computer without requiring the remote computer to have Internet access.

Briefly, the invention provides a method for printing a program from a remote computer to each one of a plurality of printers, the plurality of printers requiring a plurality of printer drivers, said method comprising the steps of providing a secondary computer having a plurality of printer drivers that facilitate the printing of the remote computer program by each one of the plurality of printers; sending the remote computer program from the remote computer to said secondary computer; and providing an interface between said secondary computer and the plurality of printers whereby a program from said remote computer is sent to and printed by each one of the plurality of printers.

The invention further provides a method for printing a program from each one of a plurality of remote computers to each one of a plurality of printers, the plurality of printers requiring a plurality of printer drivers, said method comprising the steps of providing a secondary computer having a plurality of printer drivers that facilitate the printing of the program from each one of the plurality of remote computers by each one of the plurality of printers; providing an interface between each one of the plurality of remote computers and said secondary computer; and providing an interface between said secondary computer and the plurality of printers whereby a program from each one of the plurality of remote computers is sent to and printed by each one of the plurality of printers.

The invention also provides a method for printing a program from each one of a plurality of remote computers to a printer, said method comprising the steps of providing a secondary computer having a plurality of printer drivers that facilitate the printing of the program from each one of the plurality of remote computers by the printer; sending the remote computer program from the remote computer to said secondary computer; and providing an interface between said secondary computer and the printer whereby a program from each one of the plurality of remote computers is sent to and printed by the printer.

The invention yet further provides a method for printing Internet content via a remote computer, said method comprising the steps of providing a secondary computer having a printer driver that facilitates the printing of the Internet content; sending a uniform resource locator from the remote computer to said secondary computer; downloading the Internet content to said secondary computer; and arranging the Internet content into a form that is printable whereby the Internet content is printed without requiring the remote computer to have Internet access.

### BRIEF DESCRIPTION OF THE DRAWINGS

These and other objects, advantages and novel features of the present invention, as well as details of an illustrative embodiment thereof, will be more fully understood from the following detailed description and attached drawings, wherein:

FIG. 1 is a block diagram of a method and system for printing from a handheld computer or remote computer in accordance with the present invention.

FIG. 2A is a computer screen image of a handheld printing application in accordance with the present invention.

FIG. 2B is a computer screen image of a list of memo files contained in a remote or handheld computer.

FIG. 3A is a computer screen image of a list of handheld computer application programs.

FIG. 3B is a computer screen image of a list of memo files contained on the handheld computer.

FIG. 3C is a computer screen image of a selected file contained on the handheld computer.

FIG. 4 is a computer login screen image.

FIG. 5 is a block diagram of a method and system for printing from multiple handheld computers to a single or default printer in accordance with the present invention.

FIG. 6 is a block diagram of a method and system for printing from one handheld computer to multiple printers in accordance with the present invention.

FIG. 7 is a computer screen image of four print drivers installed in a secondary computer in accordance with the present invention.

FIG. 8A is a computer screen image of a remote computer printer application user interface containing a web pages category.

FIG. 8B is a computer screen image of options to see bookmarks from browsers or the contents of a cut-and-paste clipboard.

FIG. 8C is a computer screen image of bookmarks that have been saved from the remote computer browser applications.

### DESCRIPTION OF THE PREFERRED EMBODIMENT

The present invention provides a method for printing programs and/or data from a remote computer without the need for printer drivers on the handheld. The programs and/or data are ultimately sent from the remote computer to one or more printers of a plurality of printers, the plurality of printers requiring a plurality of printer drivers to print the programs and/or data from the remote computer.

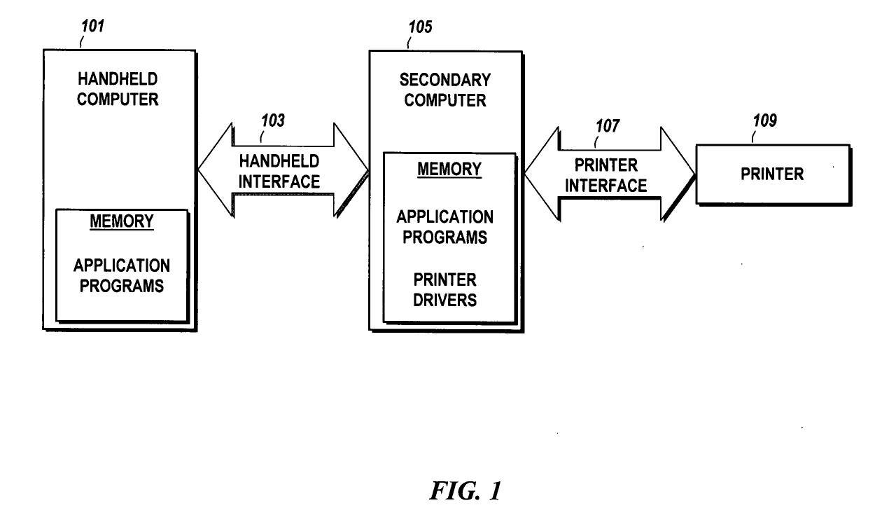

Referring now to FIG. 1, a system for printing from a handheld computer is shown in block diagram form. The system includes a handheld computer 101, a printer 109 and a secondary computer 105 such as windows OS or Macintosh desktop or laptop computer. The system also includes an interface 103 between the handheld computer 101 to the secondary computer 105, and an interface 107 between the secondary computer 105 and the printer 109.

Handheld computer 101 has memory to store application programs. The memory can be in the form of RAM, ROM, EPROM, EEPROM, FLASH, or removable memory such as Secure Digital (SD) cards or memory sticks. Examples of application programs include word processing, spread sheets, presentation programs, photograph and image viewing programs, note pad programs, etc. This list is only meant to provide some examples. Many other application programs may also be used by individual handheld users. A printing program for the handheld computer of the present invention is also stored in the application program memory. The printing program provides a list of various types of applications that the user may wish to print. The user selects the application to print and taps the print button.

Handheld interface 103 of FIG. 1 may be wired or wireless. Wired methods typically consist of a cable included with the handheld to connect it to a desktop or laptop computer. Wireless methods can include but are not limited to infrared or Radio Frequency (RF) wireless technologies. Infrared wireless schemes include TriBeam Technologies' ERIC system described in U.S. application Ser. No. 09/715,672, filed on Nov. 18, 2000 (incorporated herein by referrence), and the Infrared Data Association standard known as IrDA. RF wireless schemes include cellular phone communication systems, the IEEE networking standard 802.11 series and the Bluetooth standard. Other wired or wireless techniques may also be used and the ideas taught by the present invention are not limited to any specific interface between the handheld computer and the secondary computer. Virtually all handheld computers currently being produced and sold contain an Infrared port and are capable of IrDA communication. Some handheld computers support IEEE 802.11 RF wireless while others support Bluetooth wireless.

Secondary computer 105 of FIG. 1 contains the printer drivers. Typical operating systems include Unix, Linux, the various forms of Windows OS from Microsoft, or the various forms of Macintosh OS from Apple. The secondary computer is typically a desktop or laptop computer but may be in another form such as a network server computer or tablet PC. The secondary computer of the present invention is not limited to any particular brand of computer or operating system. A computer is configured for a printer by installing the printer drivers. The printer drivers are typically stored on the hard disk drive memory of the computer but may be stored in another fashion. Printer drivers are included, typically in CD-ROM form, with the printer for most common Operating Systems such as those mentioned along with an installation program to correctly install and configure the printer driver on the computer.

Secondary computer 105 of the present invention also contains an application program that receives the file to be printed from handheld 101 via handheld interface 103 and sends it to printer 109 via interface 107 using the installed printer driver on secondary computer 105. The secondary computer printing application program is part of the printing method of the present invention together with the printing application program of the handheld computer. Various forms of the printing programs are needed to operate on computers with different operating systems.

Printer interface 107 of FIG. 1 may be any method of allowing the secondary computer 105 to communicate with printer 109. Printer 107 may be directly connected to the secondary computer 105. Such connections include but are not limited to the IEEE standard parallel printer ports, serial ports such as the RS-232 standard, USB ports, Firewire ports, Ethernet ports or wireless connections such as infrared or Bluetooth. Printer 109 can also be configured on a computing network know as a Local Area Network (LAN). Typical LANs include Ethernet and Token Ring LANs. Such printers are known as networked printers and are not directly connected to any specific computer but rather to the LAN. In this configuration secondary computer 105 is also connected to the LAN which serves as printer interface 107.

Printer 109 of FIG. 1 can be any printer that has a printer driver installed on secondary computer 105. Any printer interfaced to secondary computer 105 with the printer driver installed can be used by handheld 101 for printing.

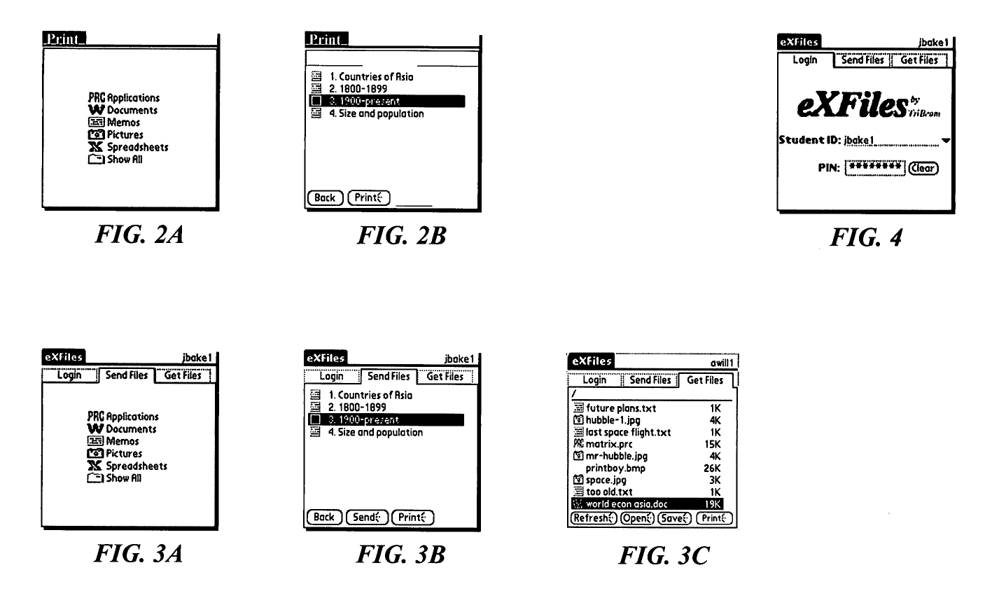

Referring now to FIG. 2A, an exemplary screen image of the handheld printing application is shown. The printing application provides a list of handheld application programs. The user selects from the list to see files of that type. In FIG. 2B, the user has selected memo files and is shown a list of memo files contained on the handheld. The user selects a file and taps the print button. The file is sent from the handheld 101 to the secondary computer 105 via handheld interface 103. Other user interface schemes on the handheld are possible and do not limit the scope of the present invention.

### DESCRIPTION OF ADDITIONAL EMBODIMENTS

Referring now to FIG. 3, the printing program can be included as part of data storage and management software such as eXFiles from TriBeam Technologies, Inc. This type of handheld application is commonly used in classrooms to allow students to exchange files with the teacher's computer which is the secondary computer 105. FIG. 3A shows a list of handheld application programs. The user selects from the list to see files of that type. In FIG. 3B, the user has selected memo files and is shown a list of memo files contained on the handheld. The use selects a file and taps the print button. The file is sent from the handheld 101 to the secondary computer 105 via handheld interface 103. The file may also be stored on the secondary computer 105. Referring now to FIG. 3C, the user has selected the get files tab and is presented with a list of the user's files stored on the secondary computer 105. The user can select a file and tap the print button. Communication between the handheld 101 and the secondary computer 105 is accomplished via handheld interface 103.

Referring now to FIG. 4, a login screen may also be used. This can be used with the basic handheld printer application of FIG. 2 or with the integrated printer application of FIG. 3. The handheld user enters a registration name in the form of a user name, student ID, or the like and may additionally be required to enter a Personal Identification Number (PIN). When the handheld executes the printing action, this information is sent to the secondary computer to authenticate the handheld user. This scheme can be used as a license mechanism for the printing software and also as an authentication mechanism to only allow authorized handheld users to print.

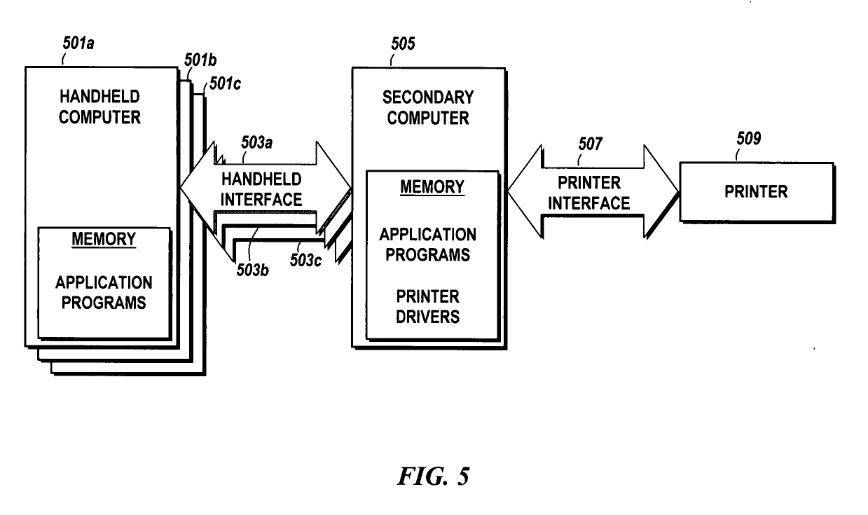

Referring now to FIG. 5, multiple handheld computers 501a, 501b and 501c may each communicate with secondary computer 505 via interfaces 503a, 503b and 503c which may or may not be the same. Otherwise, the operation of the handheld computers and handheld interfaces, and the operation of the secondary computer 503 with installed print drivers and printer application program, printer interface 507 and printer 509 is as described in the preferred embodiment of FIG. 1.

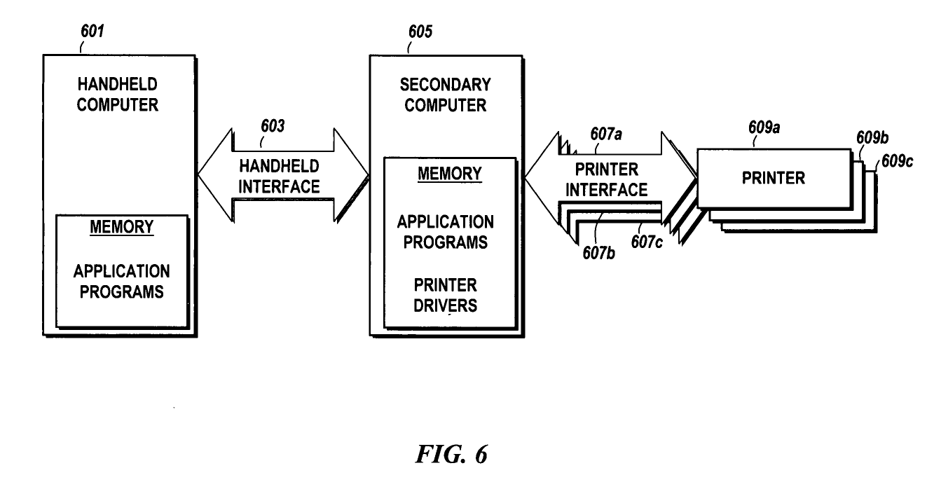

Referring now to FIG. 6, Secondary computer 605 may have many print drivers installed and may be interfaced to numerous printers 609a, 609b, and 609c via interfaces 607a, 607b, and 607c which may or may not be the same. One embodiment simply prints to the printer that is currently selected to be the default printer for secondary computer 605. In another embodiment, the handheld user is presented with a list of printers to select from where the list includes all printers with installed print drivers that are interfaced to the secondary computer. Otherwise, the operation of handheld 601 and handheld interface 603 is as described in the preferred embodiment. Further, secondary computer 605 may include the multiple handheld computers 501a, 501b and 501c described above and depicted in FIG. 5.

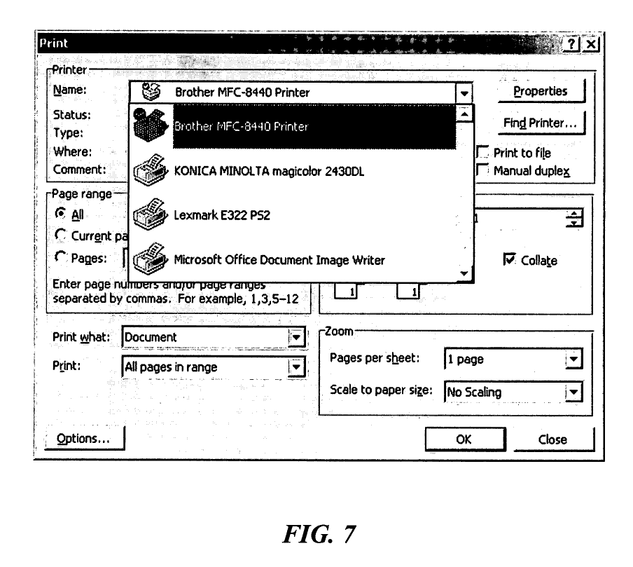

Referring now to FIG. 7, secondary computer 605 has four print drivers installed. In this example the Brother printer is interfaced via parallel port to secondary computer 605 while the Lexmark and Konica-Minolta printers reside on the Ethernet LAN along with secondary computer 605. It should be noted that the actual printer interfaces used is of no concern to the handheld user.

One of ordinary skill in the art will recognize that other embodiments are possible such as combining the ideas of FIGS. 5 and 6. Also, multiple secondary computers may be available. While the invention has been described with reference to the details of the embodiments, these details are not intended to limit the scope of the invention.

Remote computers such as handheld computers and smart phones are also capable of internet access. Internet content is typically viewed on computing devices using software programs called browsers. Common browsers for desktop and laptop computers include Internet Explorer, Netscape Navigator, Safari, and Mozilla Firefox. Typically a desktop or laptop computer comes with a browser and others can be downloaded at no cost. Many browsers are also available for remote computers such as Web Browser by Access, Palm Web Browser Pro, Handspring Blazer, and Microsoft Pocket Internet Explorer. It is desirable to be able to print Hyper Text Markup Language (“HTML”) web pages accessed and viewed on the handheld remote computer. One approach to printing web pages from a remote computer is to format and process the downloaded web page on the remote computer using an installed printer driver for the desired printer. This method of printing web pages would be required for the prior art printing method of using print drivers installed on the remote computer.

The present invention provides a method that allows a remote computer to print internet content without requiring the remote computer to include a printer driver or internet access. Referring again to FIG. 1, handheld computer 101 now includes a browser application program and has loaded and viewed a web site. Web sites are specified by a Uniform Resource Locator (“URL”), for instance www.tribeam.com. To print the tribeam web site, the handheld computer 101 simply sends the URL www.tribeam.com to the secondary computer 105 via handheld interface 103. The printing application program of the present invention operating in the secondary computer 105 receives the URL, invokes the browser in the secondary computer 105, and instructs the browser to download the web page specified by the URL. When the web page has been downloaded with the browser in the secondary computer 105, the printing application instructs the browser to queue the web page to the specified printer 109 via the printer interface 107 by using the installed printer driver in the secondary computer 105.

This method for printing internet content has advantages over the prior art. The remote or handheld computer 101 is not required to format and process the web page into a form that can be printed. Also, as described previously, the remote computer 101 does not require printer drivers to print the web page. Furthermore, the remote computer 101 simply needs to send the short URL to the secondary computer 105. There is no need to send the entire web page content. In fact, the remote computer 101 is not required to have a browser and internet access to print a web page. A web page can be printed simply by sending the URL from the remote computer 101 to the secondary computer 105. This method for printing web pages from a remote computer 101 to a printer 109 is usable irrespective of the number of remote computers 101 or printers 109.

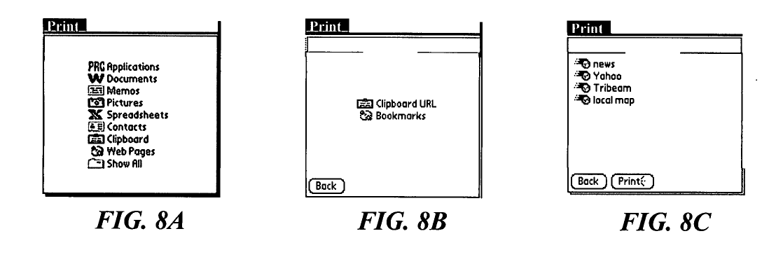

FIG. 8A shows an updated view of Remote Computer printer application user interface containing a Web Pages category. FIG. 8B shows the next screen with options to see bookmarks from browsers or the contents of the “cut-and-paste” clipboard. If the bookmarks category is selected, the screen represented by FIG. 8C is shown displaying bookmarks that have been saved from the remote computer browser applications. Alternatively, the text of a URL can be copied to the clipboard and sent to the secondary computer 105 for printing. Other user interface schemes may be included in the remote computer 101 within the scope of the present invention.

While this invention has been described with reference to its presently preferred embodiments, it not limited thereto. Rather, the invention is limited only insofar as it is defined by the following set of patent claims and includes within its scope all equivalents thereof.

1. A method for printing programs and/or data from a remote computer to one or more printers of a plurality of printers, the plurality of printers requiring a plurality of printer drivers, said method comprising the steps of:
providing a secondary computer having a plurality of printer drivers that facilitate the printing of the remote computer programs and/or data by each one of the plurality of printers;
sending the remote computer programs and/or data from the remote computer to said secondary computer; and
providing an interface between said secondary computer and the plurality of printers whereby programs and/or data from said remote computer are sent to one or more printers for printing.

2. The method of claim 1 wherein the step of providing a secondary computer includes the step of providing means for receiving the program and/or data from the remote computer.

3. The method of claim 2 wherein the step of providing receiving means includes the step of providing an application program that receives a file to be printed from the remote computer.

4. The method of claim 3 wherein the step of providing a secondary computer includes the step of providing means for sending said file to the plurality of printers.

5. The method of claim 4 wherein the step of providing means for sending said file to the plurality of printers includes the step of sending said file to a default printer.

6. The method of claim 1 wherein the step of sending the remote computer program and/or data includes the step of providing an interface between the remote computer and said secondary computer.

7. The method of claim 6 wherein the step of providing an interface between the remote computer and said secondary computer includes the step of providing a wired connection.

8. The method of claim 6 wherein the step of providing an interface between the remote computer and said secondary computer includes the step of providing a wireless connection.

9. The method of claim 1 wherein the step of providing an interface between said secondary computer and the plurality of printers includes the step of connecting said secondary computer to each one of the plurality of printers.

10. The method of claim 1 wherein the step of providing an interface between said secondary computer and the plurality of printers includes the step of networking the plurality of printers.

11. The method of claim 10 wherein the step of networking the plurality of printers includes configuring the plurality of printers on a computing network such as a local area network.

12. The method of claim 1 wherein the remote computer does not include a printer driver.

13. The method of claim 9 wherein the step of connecting said secondary computer to each one of the plurality of printers includes the step of providing a wired connection.

14. The method of claim 9 wherein the step of connecting said secondary computer to each one of the plurality of printers includes the step of providing a wireless connection.

15. The method of claim 10 wherein the step of networking the plurality of printers includes the step of providing wired connections.

16. The method of claim 10 wherein the step of networking the plurality of printers includes the step of providing wireless connections.

17. The method of claim 1 wherein the remote computer selects one or more printers for printing the programs and/or data.

18. The method of claim 1 wherein the step of providing a secondary computer includes the step of said secondary computer selecting one or more printers for printing the programs and/or data.

19. The method of claim 1 wherein the step of providing an interface between said secondary computer and the plurality of printers includes the step of providing an interface between said secondary computer and one printer.

20. A method for printing programs and/or data from one or more remote computers to one or more printers, the printers requiring a plurality of printer drivers, said method comprising the steps of:
providing a secondary computer having a plurality of printer drivers that facilitate the printing of the programs and/or data received from each one of the remote computers;
sending the remote computer programs and/or data from each one of the remote computers to said secondary computer; and
providing an interface between said secondary computer and the printers whereby programs and/or data received by said secondary computer from the remote computers are sent to one or more printers for printing.

21. The method of claim 20 wherein the remote computer selects one or more of the printers for printing the programs and/or data.

22. The method of claim 20 wherein the step of providing a secondary computer includes the step of said secondary computer selecting one or more printers for printing the programs and/or data.

23. A method for printing internet content via a remote computer, said method comprising the steps of:
providing a secondary computer that facilitates the printing of the internet content;
sending a uniform resource locator from the remote computer to said secondary computer;
downloading the internet content to said secondary computer; and
arranging the internet content into a form that is printable whereby the internet content is printed without requiring the remote computer to have internet access.

24. The method of claim 23 wherein the remote computer includes internet access.

25. The method of claim 23 wherein the remote computer includes means for downloading internet content.

26. The method of claim 23 wherein the remote computer does not include a printer driver.

27. The method of claim 23 wherein the step of providing a secondary computer includes the step of providing a printer driver in said secondary computer.

28. The method of claim 27 wherein said step of downloading the internet content includes the step of queuing the internet content for sending to a specified printer via said printer driver in said secondary computer.

29. The method of claim 28 wherein the step of sending the internet content from said secondary computer to said specified printer includes the step of providing an interface between said secondary computer and the specified printer.

30. The method of claim 23 wherein the remote computer selects one or more printers for printing internet content.

31. The method of claim 23 wherein the step of providing a secondary computer includes the step of said secondary computer selecting one or more printers to print internet content.
